(19) United States
(12) Patent Application Publication
(10) Pub. No.: US 2014/0369027 A1
(43) Pub. Date: Dec. 18, 2014

(54) COMPLEX HEAT DISSIPATION ASSEMBLY FOR BACKLIGHT MODULE

(71) Applicant: CHE YUAN WU, New Taipei City (TW)

(72) Inventor: CHE YUAN WU, New Taipei City (TW)

(21) Appl. No.: 14/023,614

(22) Filed: Sep. 11, 2013

(30) Foreign Application Priority Data
Jun. 17, 2013 (TW) 102211259

(51) Int. Cl. F21V 29/00

(52) U.S. Cl. CPC F21V 29/004
USPC 362/97.1

(57) ABSTRACT

A complex heat dissipation assembly for backlight module, which is applicable to the backlight module of a screen of an electronic product for dissipating heat. The complex heat dissipation assembly includes: a heat conduction plate assembly composed of multiple electroconductive heat conduction plates, the heat conduction plate assembly being disposed on a rear surface of the backlight module; and a heat spreader assembly composed of multiple heat spreaders, which are able to quickly transversely conduct heat. The heat spreaders are disposed between the heat conduction plates in contact therewith. The heat conduction plate assembly and the heat spreader assembly cooperate with each other to complexly conduct and spread the heat generated by the backlight module in different directions so as to prevent the heat from accumulating around the backlight module. In this case, the temperature will not locally abnormally rise.

### BACKGROUND OF THE INVENTION

1. Field of the Invention

The present invention relates generally to a complex heat dissipation assembly for backlight module, and more particularly to a low-cost and simple-structure heat conduction structure, which is able to quickly and uniformly dissipate the heat generated by the backlight module so as to avoid accumulation of the heat in a narrow space.

2. Description of the Related Art

The conventional backlight module applied to the (liquid crystal) screen of an electronic product basically includes at least one light guide plate and multiple light sources arranged on a part of the periphery of the light guide plate. (The light sources are generally cold-cathode tubes or light-emitting diodes). The light guide plate serves to uniformly spread the light emitted from the light sources to form a backlight beam as a face light source. Along with the gradual enlargement of the size of the (liquid crystal) screen, the number of the light sources is gradually increased and the power of the light sources is gradually enhanced. As a result, the heat generated by the light sources will inevitably increase. The heat must be efficiently dissipated outward by means of heat dissipation device and isolated. Otherwise, the heat will accumulate around the light sources to cause abnormal rise of the temperature of a local part of the periphery of the (liquid crystal) screen. This not only will affect the function of the electronic product, but also will shorten the lifetime of the relevant components. However, the conventional heat conduction and heat dissipation device generally has a considerably large volume and is manufactured at a higher cost. Therefore, it is unsuitable to install such heat conduction and dissipation device in the narrow space of the backside of the screen. Moreover, it is uneconomic to apply the high-price heat conduction and dissipation device to the backlight module.

It is therefore tried by the applicant to provide a low-cost, small-volume and simple-structure complex heat dissipation assembly for backlight module to overcome the above problems.

### SUMMARY OF THE INVENTION

It is therefore a primary object of the present invention to provide a complex heat dissipation assembly for backlight module, which is able to quickly outward dissipate the heat generated by the backlight module so as to effectively lower the temperature of the backlight module and enhance the heat dissipation efficiency for the backlight module.

It is a further object of the present invention to provide the above complex heat dissipation assembly for backlight module, which is able to quickly uniformly outward dissipate the heat generated by the light source assembly of the backlight module so as to avoid concentration of the heat around the backlight module. Accordingly, the temperature of the surrounding of the light source assembly will not locally abnormally rise.

It is still a further object of the present invention to provide the above complex heat dissipation assembly for backlight module, which is able to achieve excellent heat dissipation effect without using expensive heat conduction component. Therefore, the manufacturing cost is lowered to promote the economic efficiency.

To achieve the above and other objects, the complex heat dissipation assembly for backlight module of the present invention includes: at least one light source assembly capable of emitting light, the light source assembly being at least partially disposed on a periphery of a panel provided with the backlight module; a heat conduction plate assembly composed of multiple stacked electroconductive heat conduction plates; and a heat spreader assembly composed of multiple heat spreaders, which are able to quickly conduct heat along the surface. The heat spreaders are alternately disposed between the heat conduction plates. At least one of the heat conduction plate assembly and the heat spreader assembly is in contact with the light source assembly.

In the above complex heat dissipation assembly for backlight module, each heat conduction plate has a heat spreader in adjacency to and corresponding to the heat conduction plate. The heat spreader is disposed on one face of the adjacent and corresponding heat conduction plate, which face is proximal to the light source assembly.

In the above complex heat dissipation assembly for backlight module, both the heat conduction plate assembly and the heat spreader assembly are in contact with the light source assembly.

In the above complex heat dissipation assembly for backlight module, heat-conducting adhesive is disposed between the light source assembly and at least one of the heat conduction plate assembly and the heat spreader assembly.

In the above complex heat dissipation assembly for backlight module, each heat conduction plate has a heat spreader in adjacency to and corresponding to the heat conduction plate. The heat spreader is disposed on one face of the adjacent and corresponding heat conduction plate, which face is distal from the light source assembly.

In the above complex heat dissipation assembly for backlight module, the heat conduction plate assembly is in contact with the light source assembly and the heat-conducting adhesive is disposed between the heat conduction plate assembly and the light source assembly.

In the above complex heat dissipation assembly for backlight module, the heat conduction plates and the heat spreaders respectively have corresponding bent edges on the same side. The bent edges are bent toward the light source assembly.

In the above complex heat dissipation assembly for backlight module, the heat spreaders have an area smaller than that of the heat conduction plate in contact with the heat spreaders.

In the above complex heat dissipation assembly for backlight module, the heat spreaders are elongated plate-shaped bodies.

In the above complex heat dissipation assembly for backlight module, each of the heat spreaders has at least one branch section obliquely extending from one side of the heat spreader, which side is distal from the bent edge.

In the above complex heat dissipation assembly for backlight module, the branch section obliquely extends in a direction away from the light source assembly and the bent edge.

In the above complex heat dissipation assembly for backlight module, heat-conducting electroconductive adhesive layers are respectively disposed between the heat conduction plates and the heat spreaders.

In the above complex heat dissipation assembly for backlight module, the panel is disposed in a screen frame and the heat conduction plate assembly and the heat spreader assembly are disposed in a space defined by the screen frame and a backboard.

The present invention can be best understood through the following description and accompanying drawings, wherein:

### BRIEF DESCRIPTION OF THE DRAWINGS

FIG. 1 is a perspective exploded view of a first embodiment of the present invention;

FIG. 2 is a perspective partially assembled view of the first embodiment of the present invention;

FIG. 3 is a sectional assembled view of the first embodiment of the present invention;

FIG. 4 is a perspective exploded view of a second embodiment of the present invention;

FIG. 5 is a perspective exploded view of a third embodiment of the present invention; and

FIG. 6 is a sectional assembled view of a fourth embodiment of the present invention.

### DETAILED DESCRIPTION OF THE PREFERRED EMBODIMENTS

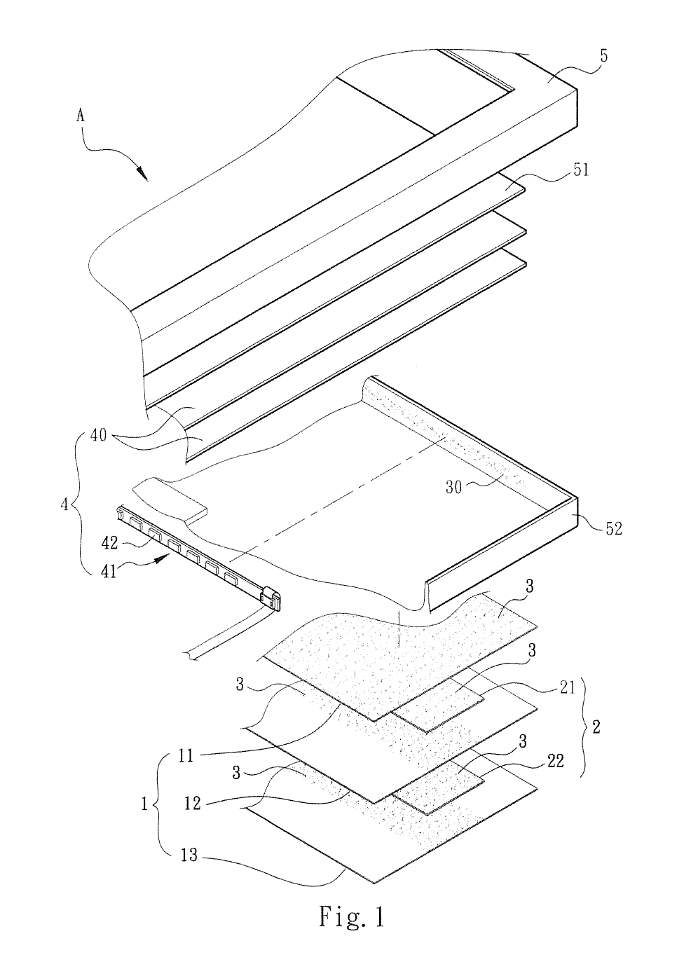

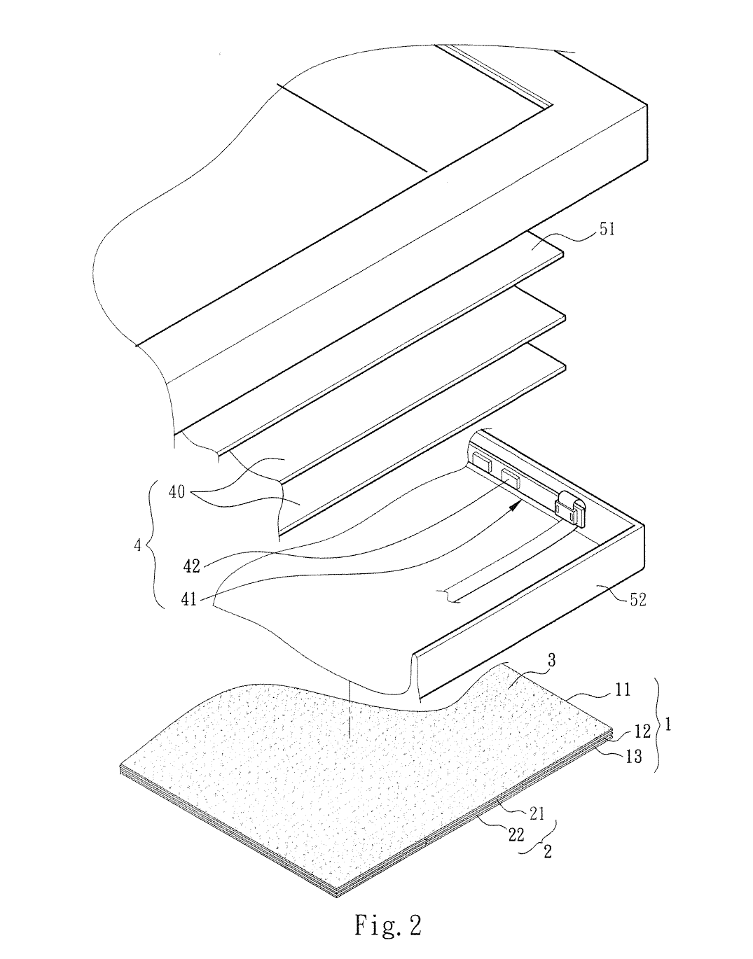

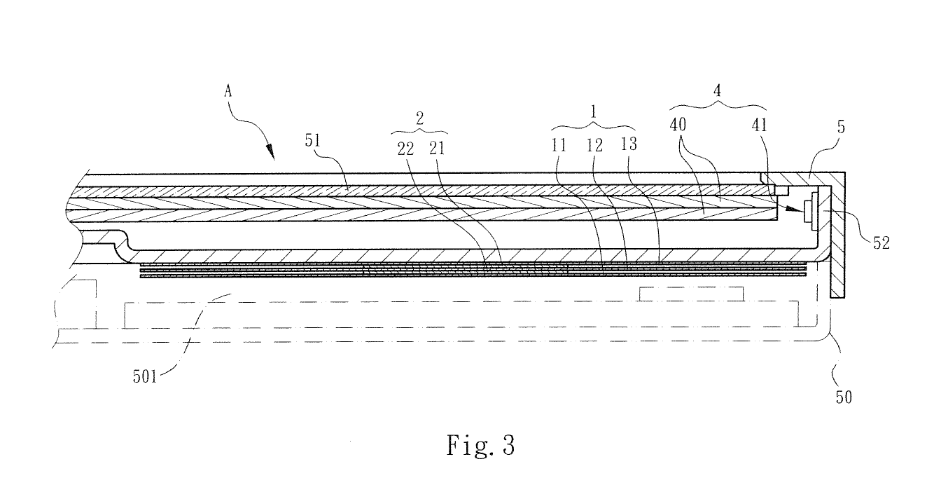

Please refer to FIGS. 1 to 3. According to a first embodiment, the complex heat dissipation assembly for backlight module of the present invention includes a heat conduction plate assembly 1 and a heat spreader assembly 2. The heat conduction plate assembly 1 is composed of multiple sequentially stacked electroconductive heat conduction plates 11, 12, 13, (which can be made of metal material). The heat spreader assembly 2 is composed of multiple heat spreaders 21, 22 respectively alternately disposed between the heat conduction plates 11, 12, 13. The heat spreaders 21, 22 have an area smaller than that of the heat conduction plates 11, 12, 13. The heat spreaders 21, 22 can be made of graphite or the like material. The heat spreaders 21, 22 have a property of quickly conducting heat along the surface (transversely), whereby the heat will not easily directly penetrate through the heat spreaders 21, 22. In this embodiment, the heat spreaders 21, 22 are elongated plate bodies. The heat spreaders 21, 22 and the heat conduction plates 11, 12, 13 are electrically bonded to each other by means of heat-conducting electroconductive adhesive layers 3.

In application, the heat conduction plate assembly 1 and the heat spreader assembly 2 are arranged on a backside of a screen A. The screen A is composed of a (liquid crystal) panel 51 and a backlight module 4. The liquid crystal panel 51 is disposed in a screen frame 5. The backlight module 4 is attached to a backside of the liquid crystal panel 51. A backboard 52 with excellent heat conductivity is disposed on the other side of the backlight module 4 and connected with the screen frame 5. The backlight module 4 is composed of at least one light guide plate 40 attached to the backside of the liquid crystal panel 51 and a light source assembly 41 at least partially disposed on a periphery of the light guide plate 40. The light source assembly 41 includes multiple light-emitters 42 arranged at intervals. Electroconductive heat-conducting adhesive 30 can be disposed between the light source assembly 41 and the periphery of the backboard 52 as necessary. The screen A is connectable to a case 50 of an electronic product. The case 50 and the screen A define therebetween a receiving space 401 for receiving other electronic components therein. The heat conduction plate assembly 1 is attached to a rear surface of the backboard 52. Electroconductive adhesive layer 3 can be disposed between the heat conduction plate assembly 1 and the backboard 52.

In this embodiment, the number of the heat conduction plates of the heat conduction plate assembly 1 and the number of the heat spreaders of the heat spreader assembly 2 can be increased or decreased as necessary to form different heat conduction and dissipation assemblies.

In use, the heat generated by the light source assembly 41 passes through the heat-conducting adhesive 30 and is conducted to the backboard 52. Then the heat is conducted from the backboard 52 to the heat conduction plate 11. The heat conduction plates 11, 12, 13 are plate-shaped bodies and made of metal material so that the heat conduction plates 11, 12, 13 are able to radially uniformly spread the heat at equal speed. Accordingly, the heat will very quickly pass through the heat conduction plate 11 and be transferred from the electroconductive adhesive layer 3 to the heat spreader 21. Due to the property of quickly conducting heat along the surface (transversely) of the heat spreaders 21, 22, the heat is quickly spread and uniformly distributed over the surface of the heat spreader 21. Then the heat is sequentially conducted from the electroconductive adhesive layer 3 to the heat conduction plate 12, the heat spreader 22 and the heat conduction plate 13. Accordingly, thanks to the property of transversely complexly spreading heat of the heat spreaders 21, 22 and the property of quickly directly outward dissipating heat of the heat conduction plates 11, 12, 13, the heat is effectively prevented from accumulating around the light source assembly 41. In this case, the temperature will not locally abnormally rise.

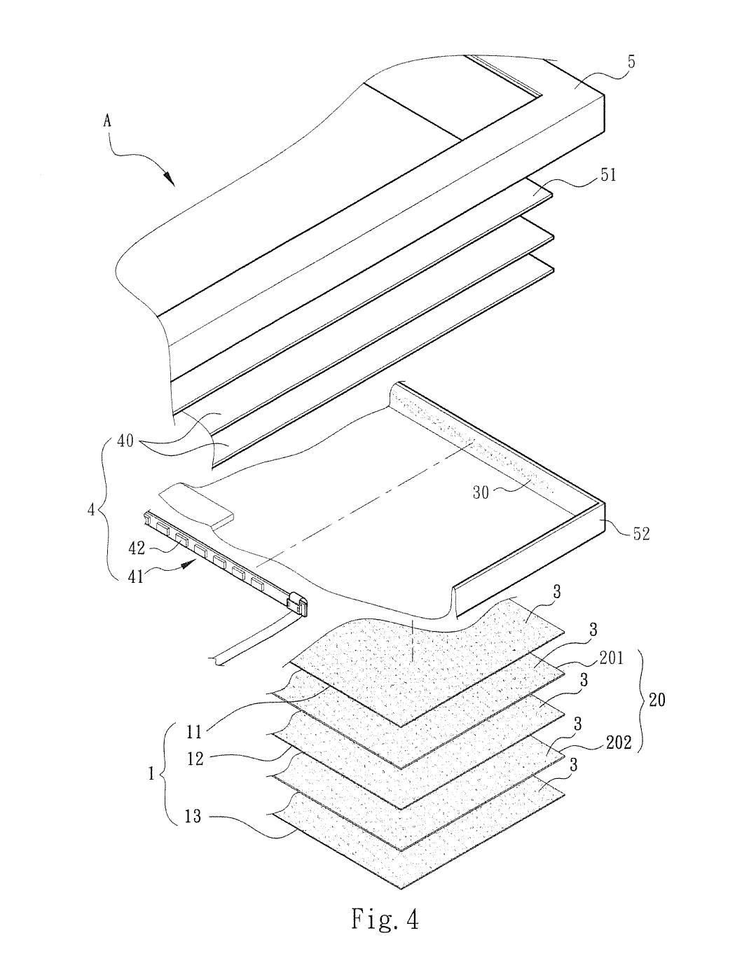

Please refer to FIG. 4. According to a second embodiment, the complex heat dissipation assembly for backlight module of the present invention includes a heat spreader assembly 20 and a heat conduction plate assembly 1 identical to that of the first embodiment. The heat conduction plate assembly 1 identically includes multiple heat conduction plates 11, 12, 13. The heat spreader assembly 20 is composed of multiple heat spreaders 201, 202 respectively alternately disposed between the heat conduction plates 11, 12, 13. The heat spreaders 201, 202 have an area equal to that of the heat conduction plates 11, 12, 13. The heat spreaders 201, 202 can be made of graphite or the like material. The heat spreaders 201, 202 have a property of quickly conducting heat along the surface (transversely), whereby the heat will not easily directly penetrate through the heat spreaders 201, 202. The heat spreaders 201, 202 and the heat conduction plates 11, 12, 13 are electrically bonded to each other by means of heat-conducting electroconductive adhesive layers 3.

The assembling manner and the application of the heat spreader assembly 20 and the heat conduction plate assembly 1 of the second embodiment are identical to that of the first embodiment.

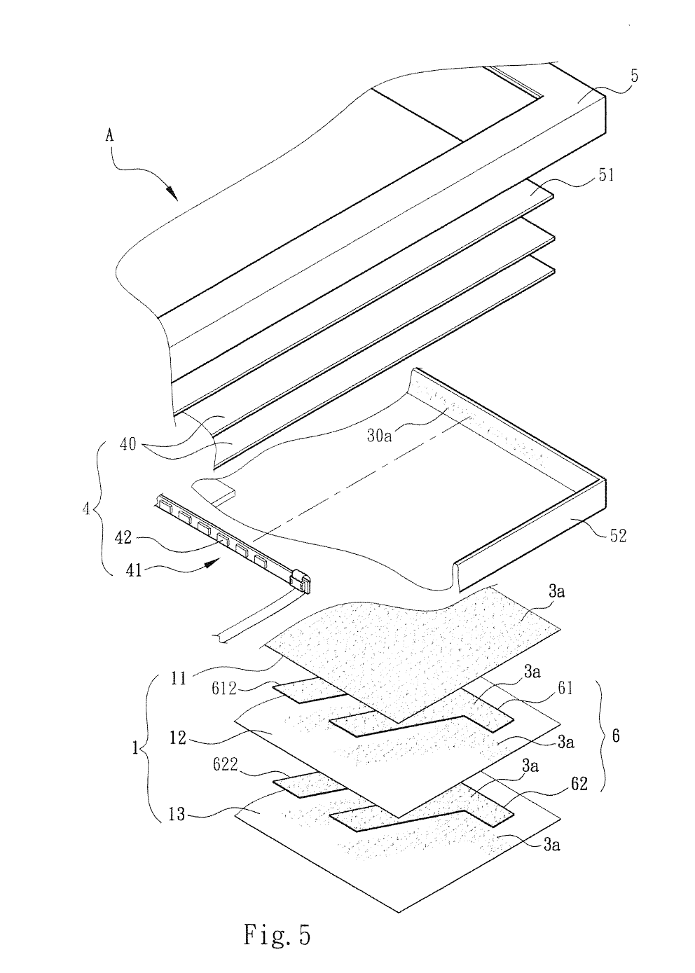

Please refer to FIG. 5. According to a third embodiment, the complex heat dissipation assembly for backlight module of the present invention includes a heat spreader assembly 6 and a heat conduction plate assembly 1 identical to that of the first embodiment. The heat conduction plate assembly 1 identically includes multiple heat conduction plates 11, 12, 13. The heat spreader assembly 6 is composed of multiple heat spreaders 61, 62 respectively alternately disposed between the heat conduction plates 11, 12, 13. The heat spreaders 61, 62 have an area smaller than that of the heat conduction plate assembly 1. The heat spreaders 61, 62 can be made of graphite or the like material. The heat spreaders 61, 62 have a property of quickly conducting heat along the surface (transversely). In this embodiment, each of the heat spreaders 61, 62 has multiple branch sections 612, 622 obliquely extending from one side of the heat spreader 61, 62 in parallel to each other. The heat spreaders 61, 62 and the heat conduction plates 11, 12, 13 are electrically bonded to each other by means of heat-conducting electroconductive adhesive layers 3a.

In this embodiment, the number of the heat conduction plates of the heat conduction plate assembly 1 and the number of the heat spreaders of the heat spreader assembly 6 can be increased or decreased as necessary to form different heat conduction and dissipation assemblies.

In application, as in the first embodiment, the heat conduction plate assembly 1 and the heat spreader assembly 6 are arranged on the backside of the screen A. The light source assembly 41 is connected to the backboard 52 via heat-conducting adhesive 30a. In use, the heat generated by the light source assembly 41 passes through the heat-conducting adhesive 30a and is conducted to the backboard 52. Then the heat is sequentially conducted from the backboard 52 through the electroconductive adhesive layer 3a to the heat conduction plate 11, the heat spreader 61, the heat conduction plate 12, the heat spreader 62 and the heat conduction plate 13. Accordingly, thanks to the property of transversely complexly spreading heat of the heat spreaders 61, 62 and the property of quickly directly outward dissipating heat of the heat conduction plates 11, 12, 13, the heat is effectively prevented from accumulating around the light source assembly 41. In this case, the temperature will not locally abnormally rise.

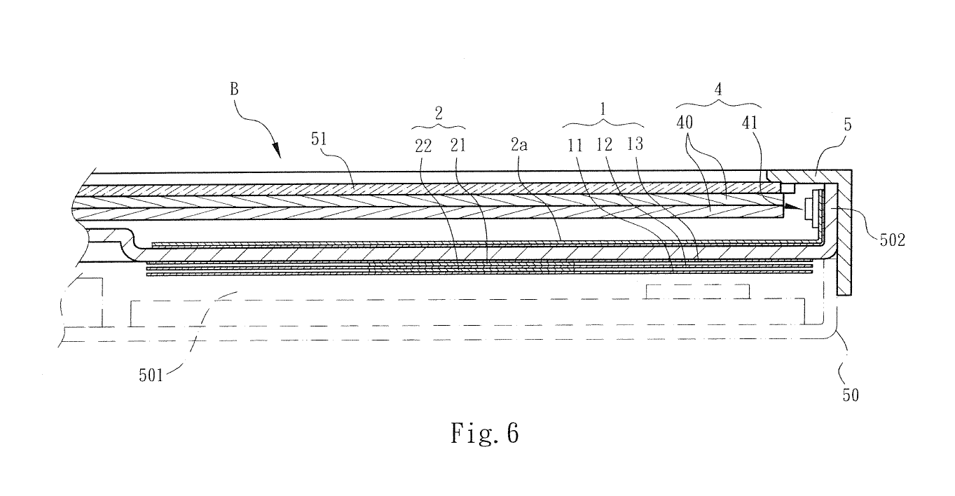

FIG. 6 shows a fourth embodiment of the present invention, which is a modification of the first embodiment. According to the fourth embodiment, the complex heat dissipation assembly for backlight module of the present invention includes a heat spreader assembly 2 identical to that of the first embodiment and a heat conduction plate assembly 1. The heat conduction plate assembly 1 and the heat spreader assembly 2 are assembled in the same manner as the first embodiment.

In application, the heat conduction plate assembly 1 and the heat spreader assembly 2 are arranged on a backside of a screen B. The screen B is composed of a (liquid crystal) panel 51 and a backlight module 4. The liquid crystal panel 51 is disposed in a screen frame 5. The backlight module 4 is attached to a backside of the liquid crystal panel 51. A backboard 502 with poor heat conductivity (or without heat conductivity) is disposed on the other side of the backlight module L and connected with the screen frame 5. The backlight module 4 is composed of at least one light guide plate 40 attached to the backside of the panel 51 and a light source assembly 41 at least partially disposed on a periphery of the light guide plate 40. The light source assembly 41 includes multiple light-emitters 42 arranged at intervals. The screen B is connectable to a case 50 of an electronic product. The case 50 and the screen B define therebetween a receiving space 401 for receiving other electronic components therein. The heat conduction plate assembly is attached to a rear surface of the backboard 502. Electroconductive adhesive layer can be disposed between the heat conduction plate assembly 1 and the backboard 502 as necessary.

In the above structure, the backboard 502 itself has poor heat conductivity (or has no heat conductivity). Therefore, a heat spreader 2a can be disposed between the light source assembly 41 and the periphery of the backboard 502 as necessary. In addition, as necessary, the backboard 502 is formed with densely arranged perforations or the like mechanisms for the heat to pass through (not shown) on a section covered by the heat spreader 2a. In this case, the heat of the light source assembly 41 can be first uniformly spread by the heat spreader 2a and then pass through the backboard 502 to be sequentially conducted to the heat conduction plate 11, the heat spreader 21, the heat conduct ion plate 12, the heat spreader 22 and the heat conduction plate 13. Similarly, this can achieve the same heat dissipation effect.

In conclusion, the complex heat dissipation assembly for backlight module of the present invention can truly quickly and uniformly dissipate the heat generated by the backlight module. Moreover, the complex heat dissipation assembly for backlight module of the present invention is manufactured at lower cost and is applicable to a narrow space.

The above embodiments are only used to illustrate the present invention, not intended to limit the scope thereof. Many modifications of the above embodiments can be made without departing from the spirit of the present invention.

What is claimed is:

1. A complex heat dissipation assembly for backlight module, comprising:
at least one light source assembly capable of emitting light, the light source assembly being at least partially disposed on a periphery of a panel provided with the backlight module and positioned between the panel and a backboard;
a heat conduction plate assembly composed of multiple stacked electroconductive heat conduction plates; and
a heat spreader assembly composed of multiple heat spreaders, which are able to quickly conduct heat along the surface, the heat spreaders being alternately disposed between the heat conduction plates, one face of the heat conduction plate assembly being attached to and in contact with a rear surface of the backboard in adjacency to the light source assembly.

2. The complex heat dissipation assembly for backlight module as claimed in claim 1, wherein each heat conduction plate has a heat spreader in adjacency to and corresponding to the heat conduction plate, the heat spreader being disposed on one face of the adjacent and corresponding heat conduction plate, which face is proximal to the light source assembly.

3. The complex heat dissipation assembly for backlight module as claimed in claim 2, wherein heat-conducting adhesive is disposed between the heat conduction plate assembly and the backboard.

4. The complex heat dissipation assembly for backlight module as claimed in claim 1, wherein each heat conduction plate has a heat spreader in adjacency to and corresponding to the heat conduction plate, the heat spreader being disposed on one face of the adjacent and corresponding heat conduction plate, which face is distal from the backboard.

5. The complex heat dissipation assembly for backlight module as claimed in claim 4, wherein the heat conduction plate assembly is in contact with the backboard and heat-conducting adhesive is disposed between the heat conduction plate assembly and the backboard.

6. The complex heat dissipation assembly for backlight module as claimed in claim 1, wherein the heat spreaders have an area equal to that of the heat conduction plate in contact with the heat spreaders.

7. The complex heat dissipation assembly for backlight module as claimed in claim 2, wherein the heat spreaders have an area equal to that of the heat conduction plate in contact with the heat spreaders.

8. The complex heat dissipation assembly for backlight module as claimed in claim 4, wherein the heat spreaders have an area equal to that of the heat conduction plate in contact with the heat spreaders.

9. The complex heat dissipation assembly for backlight module as claimed in claim 1, wherein the heat spreaders have an area smaller than that of the heat conduction plate in contact with the heat spreaders.

10. The complex heat dissipation assembly for backlight module as claimed in claim 2, wherein the heat spreaders have an area smaller than that of the heat conduction plate in contact with the heat spreaders.

11. The complex heat dissipation assembly for backlight module as claimed in claim 4, wherein the heat spreaders have an area smaller than that of the heat conduction plate in contact with the heat spreaders.

12. The complex heat dissipation assembly for backlight module as claimed in claim 6, wherein the heat spreaders are elongated plate-shaped bodies.

13. The complex heat dissipation assembly for backlight module as claimed in claim 9, wherein the heat spreaders are elongated plate-shaped bodies.

14. The complex heat dissipation assembly for backlight module as claimed in claim 10, wherein the heat spreaders are elongated plate-shaped bodies.

15. The complex heat dissipation assembly for backlight module as claimed in claim 11, wherein the heat spreaders are elongated plate-shaped bodies.

16. The complex heat dissipation assembly for backlight module as claimed in claim 6, wherein each of the heat spreaders has at least one branch section obliquely extending from one side of the heat spreader, which side is distal from the light source assembly.

17. The complex heat dissipation assembly for backlight module as claimed in claim 9, wherein each of the heat spreaders has at least one branch section obliquely extending from one side of the heat spreader, which side is distal from the light source assembly.

18. The complex heat dissipation assembly for backlight module as claimed in claim 10, wherein each of the heat spreaders has at least one branch section obliquely extending from one side of the heat spreader, which side is distal from the light source assembly.

19. The complex heat dissipation assembly for backlight module as claimed in claim 11, wherein each of the heat spreaders has at least one branch section obliquely extending from one side of the heat spreader, which side is distal from the light source assembly.

20. The complex heat dissipation assembly for backlight module as claimed in claim 16, wherein the branch section obliquely extends in a direction away from the light source assembly.

21. The complex heat dissipation assembly for backlight module as claimed in claim 17, wherein the branch section obliquely extends in a direction away from the light source assembly.

22. The complex heat dissipation assembly for backlight module as claimed in claim 1, wherein heat-conducting electroconductive adhesive layers are respectively disposed between the heat conduction plates and the heat spreaders.

23. The complex heat dissipation assembly for backlight module as claimed in claim 2, wherein heat-conducting electroconductive adhesive layers are respectively disposed between the heat conduction plates and the heat spreaders.

24. The complex heat dissipation assembly for backlight module as claimed in claim 4, wherein heat-conducting electroconductive adhesive layers are respectively disposed between the heat conduction plates and the heat spreaders.

25. The complex heat dissipation assembly for backlight module as claimed in claim 6, wherein heat-conducting electroconductive adhesive layers are respectively disposed between the heat conduction plates and the heat spreaders.

26. The complex heat dissipation assembly for backlight module as claimed in claim 9, wherein heat-conducting electroconductive adhesive layers are respectively disposed between the heat conduction plates and the heat spreaders.

27. The complex heat dissipation assembly for backlight module as claimed in claim 12, wherein heat-conducting electroconductive adhesive layers are respectively disposed between the heat conduction plates and the heat spreaders.

28. The complex heat dissipation assembly for backlight module as claimed in claim 16, wherein heat-conducting electroconductive adhesive layers are respectively disposed between the heat conduction plates and the heat spreaders.

29. The complex heat dissipation assembly for backlight module as claimed in claim 20, wherein heat-conducting electroconductive adhesive layers are respectively disposed between the heat conduction plates and the heat spreaders.

30. The complex heat dissipation assembly for backlight module as claimed in claim 1, wherein the backboard is disposed in a screen frame and a case and the heat conduction plate assembly and the heat spreader assembly are disposed in a space defined by the screen frame and the case.

31. The complex heat dissipation assembly for backlight module as claimed in claim 2, wherein the backboard is disposed in a screen frame and a case and the heat conduction plate assembly and the heat spreader assembly are disposed in a space defined by the screen frame and the case.

32. The complex heat dissipation assembly for backlight module as claimed in claim 4, wherein the backboard is disposed in a screen frame and a case and the heat conduction plate assembly and the heat spreader assembly are disposed in a space defined by the screen frame and the case.

33. The complex heat dissipation assembly for backlight module as claimed in claim 6, wherein the backboard is disposed in a screen frame and a case and the heat conduction plate assembly and the heat spreader assembly are disposed in a space defined by the screen frame and the case.

34. The complex heat dissipation assembly for backlight module as claimed in claim 9, wherein the backboard is disposed in a screen frame and a case and the heat conduction plate assembly and the heat spreader assembly are disposed in a space defined by the screen frame and the case.

35. The complex heat dissipation assembly for backlight module as claimed in claim 12, wherein the backboard is disposed in a screen frame and a case and the heat conduction plate assembly and the heat spreader assembly are disposed in a space defined by the screen frame and the case.

36. The complex heat dissipation assembly for backlight module as claimed in claim 16, wherein the backboard is disposed in a screen frame and a case and the heat conduction plate assembly and the heat spreader assembly are disposed in a space defined by the screen frame and the case.

37. The complex heat dissipation assembly for backlight module as claimed in claim 20, wherein the backboard is disposed in a screen frame and a case and the heat conduction plate assembly and the heat spreader assembly are disposed in a space defined by the screen frame and the case.

38. The complex heat dissipation assembly for backlight module as claimed in claim 22, wherein the backboard is disposed in a screen frame and a case and the heat conduction plate assembly and the heat spreader assembly are disposed in a space defined by the screen frame and the case.
